(19) United States
(12) Patent Application Publication
(10) Pub. No.: US 2021/0381765 A1
(43) Pub. Date: Dec. 9, 2021

(54) Ultrasonic-Assisted Liquid Manipulation

(71) Applicant: ULTRAHAPTICS IP LTD, Bristol (GB)

(72) Inventors: Brian Kappus, Mountain View, CA (US); Benjaimin John Oliver Long, Bristol (GB)

(21) Appl. No.: 17/409,783

(22) Filed: Aug. 23, 2021

Related U.S. Application Data
(63) Continuation of application No. 16/563,608, filed on Sep. 6, 2019, now Pat. No. 11,098,951.
(60) Provisional application No. 62/728,829, filed on Sep. 9, 2018.

(51) Int. Cl. F26B 5/02

(52) U.S. Cl. CPC F26B 5/02

(57) ABSTRACT

A phased array of ultrasonic transducers may create arbitrary fields that can be utilized to manipulate fluids. This includes the translation of drops on smooth surfaces as well speeding the evaporation of fluids on wetted hands. Proposed herein is the use airborne ultrasound focused to the surface of the hand. The risk is that coupling directly into the bulk of the hand may cause damage to the cellular material through heating, mechanical stress, or cavitation. Using a phased array, the focus may be moved around, thus preventing acoustic energy from lingering too long on one particular position of the hand. While some signaling may penetrate into the hand, most of the energy (99.9%) is reflected. Also disclosed are methods to couple just to the wetted surface of the hand.

### RELATED APPLICATION

This application claims the benefit of the following U.S. Provisional Patent Applications, which is incorporated by reference in its entirety:

1) Ser. No. 62/728,829, filed on Sep. 9, 2018.

### FIELD OF THE DISCLOSURE

The present disclosure relates generally to improved techniques for manipulation of liquids using ultrasonic signals.

### BACKGROUND

A continuous distribution of sound energy, which we will refer to as an “acoustic field”, can be used for a range of applications including haptic feedback in mid-air.

High-powered ultrasound is well known in the food-drying market. The sound-energy is pumped into the bulk of the fruit/vegetables directly either through a coupling medium (that may be oil-based) or through the air in a resonator (to avoid too much loss). This results in a measurable increase in drying speed. There are various theories attempting to explain the phenomena (discussed below).

More generally, liquid manipulation without direct contact may be used in manufacturing techniques which that soluble materials. This avoids contamination or corrosion that could substantially improve manufacturing efficiencies.

Hand-drying is a common aspect of public restrooms across the world. Forced air dryers are hygienic and energy-efficient but often too slow or loud for many users. These people often resort to wasteful paper towels. If it was possible to speed drying or make it relatively quiet, this would increase usage rates and lower costs associated with maintaining the restroom.

### SUMMARY

A phased array of ultrasonic transducers may create arbitrary fields that can be utilized to manipulate fluids. This includes the translation of drops on smooth surfaces as well speeding the evaporation of fluids on wetted hands. Ultrasound signals may be used to manipulate liquids by interacting with the resulting acoustic pressure field.

Proposed herein is the use airborne ultrasound focused to the surface of the hand. The risk is that coupling directly into the bulk of the hand may cause damage to the cellular material through heating, mechanical stress, or cavitation. Using a phased array, the focus may be moved around, thus preventing acoustic energy from lingering too long on one particular position of the hand. While some signaling may penetrate into the hand, most of the energy (99.9%) is reflected. Methods are discussed to couple just to the wetted surface of the hand as well.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIG. 1 is a schematic showing acoustic fields pushing water towards the tips of the fingers so that it can pool and fall away.

FIG. 2 is a schematic showing a moving pressure field pushes water towards the tips of each of the fingers to pool and fall away.

FIGS. 3A. 3B and 3C are schematics showing oscillating pressure fields that launch capillary waves into a convergence point of highest pressure.

FIGS. 4A, 4B and 4C are schematics showing translating pressure fields that launch capillary waves into a convergence point of highest pressure.

FIGS. 5A and 5B are schematics showing diagonal converging nonlinear pressure fields that yield sharp features.

FIGS. 6A and 6B are schematics showing facing converging nonlinear pressure fields that yield sharp features.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Airborne ultrasound is composed of longitudinal pressure waves at frequencies beyond the range of human hearing. These waves carry energy and can be used to excite waves in other objects (such as create haptic feedback on skin) and do mechanical work (such as levitating or pushing objects).

### I. USING ULTRASONIC FIELDS TO MANIPULATE LIQUIDS

The nonlinear pressure field created at high ultrasonic sound pressure level (SPL) includes a static pressure component. This pressure can be used to manipulate liquid droplets on surfaces which are at least slightly phobic to that liquid (for instance hydrophobic surfaces and water). If a focus point is created near a droplet, the droplet will be repulsed. This is a method for translating this droplet without direct contact.

In embodiments of this invention, a phased array of ultrasonic transducers is placed nearby the surface of interaction and creates a field on that surface with high-pressure regions used to push drops or liquid channels. These regions may be arbitrarily shaped and may be manipulated dynamically to achieve the desired translation. With enough resolution (i.e., high-frequency) drops may be diced into sub-drops and separated in a controlled manner. Further, directing a focus point of the phased array to the surface of a liquid that is at least a few wavelengths deep can cause the capture of gas droplets from the nearby gas interface. This can be used to mix gasses into the liquid or simply help agitate/mix the solution.

It has recently been discovered that high-intensity airborne ultrasound can effectively speed up the drying process for fruits and vegetables. The process can involve high temperatures (up to 70° C.) but this is not required. In fact, ultrasound makes the largest difference when drying at lower temperatures.

In embodiments of this invention, ultrasonic-assisted drying may be used to speed the de-wetting of hands in a safe and controlled manner.

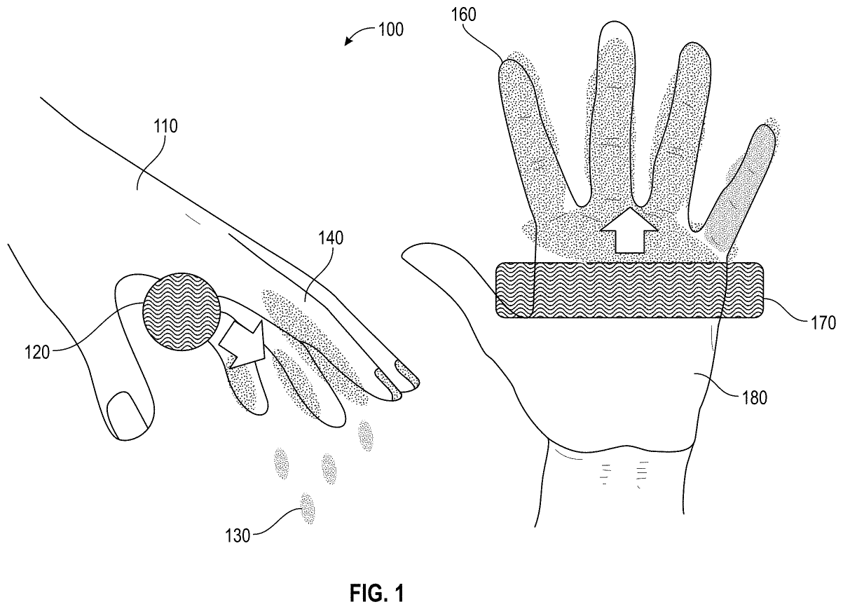

Turning to FIG. 1, shown is a schematic 100 of two hands interacting with moving ultrasonic fields. On the left, dry skin 110 is formed when a moving sound field 120 of a generally circular shape “pushes” drops 130 off the hand. On the right, dry skin 180 is formed when a moving sound field 170 of a generally rectangular shape “pushes” wetness 160 off the hand.

In this arrangement, acoustic pressure may be used to manipulate a thin film of water on a wetted hand much as it may manipulate fluids on a surface described above. An acoustic focal area, which may be made into any shape such as a point or line, is translated to push the water film off the hand even as the hand itself is moving. The de-wetting process may be accomplished by bunching enough water together (for instance near the fingertips) when the hand is pointed down, so that it forms a droplet and falls away (left side). Alternatively, this technique may be paired with forced air so that the ultrasound pressure pushes the wetted film towards areas with the highest (or most effective) forced air (right side).

There are two primary mechanisms beyond the physical pushing of water that may assist drying: enhanced mass-transfer and atomization. One or both of these drying-assist mechanisms may be exploited in various arrangements presented below.

For enhanced mass-transfer, during each cycle of sound there is alternating high-pressure and low-pressure that mechanically compresses and decompresses the medium. During the compression cycle, moisture is pushed out of compressible cavities like a sponge. During rarefaction, the water is pushed away by the expanding cavities instead of back into them. No longer trapped by the cavities, the water is free to flow along gradients to areas of lower moisture. This improves the ability of water to move in a semi-solid environment and brings water to the surface more quickly in a drying environment.

Atomization has been popularized as ultrasonic foggers. In these devices, high-intensity ultrasound is generated by a transducer submerged in water which excites capillary waves on the surface. At sufficient amplitude, the capillary waves become unstable and droplets are pinched off into the air forming a visible mist. In the context of drying, capillary wave-produced droplets effectively remove moisture from the surface of the object. The capillary wave-produced droplets may then be removed from the vicinity with gradients in pressure from one or more of: (a) a sound field; (b) forced air; and (c) heat-assisted evaporation (which is very effective due to the capillary wave-produced droplets high surface-area-to-volume ratio).

Both mass transfer enhancement and atomization are threshold phenomena. A focused sound field may create the necessary high-pressures without a sophisticated resonance chamber. In one arrangement of this invention, a phased array is placed near the user's hands and a focal point is created on the hand to promote mass transfer of moisture to the surface and atomization. Forced and/or heated air will further improve the drying speed if desired.

With the application of high intensity ultrasound comes mechanical heating and potential damage to the skin. Both mass transfer and atomization are fast phenomenon, taking only a few cycles of sound to start being effective. Mechanical heating, on the other hand, can take many cycles build up a damaging temperature. A phased array may translate the focal point to avoid any tissue damage. Drying would still be enhanced by crossing the pressure threshold for the dying phenomena while not lingering long enough to deposit a damaging amount of energy to the skin.

Of the two effects, atomization by capillary waves is preferred in the hand drying context as it forces moisture away from surface of the skin without heating the water or mechanically driving the medium. Capillary waves will be excited by any incident ultrasound. Optimal coupling, and therefore maximum atomization for a given sound pressure, may be achieved through specific arrangements of the sound field (described below). In these arrangements, some enhancement by mass transfer will be inevitable and will only help to speed the drying.

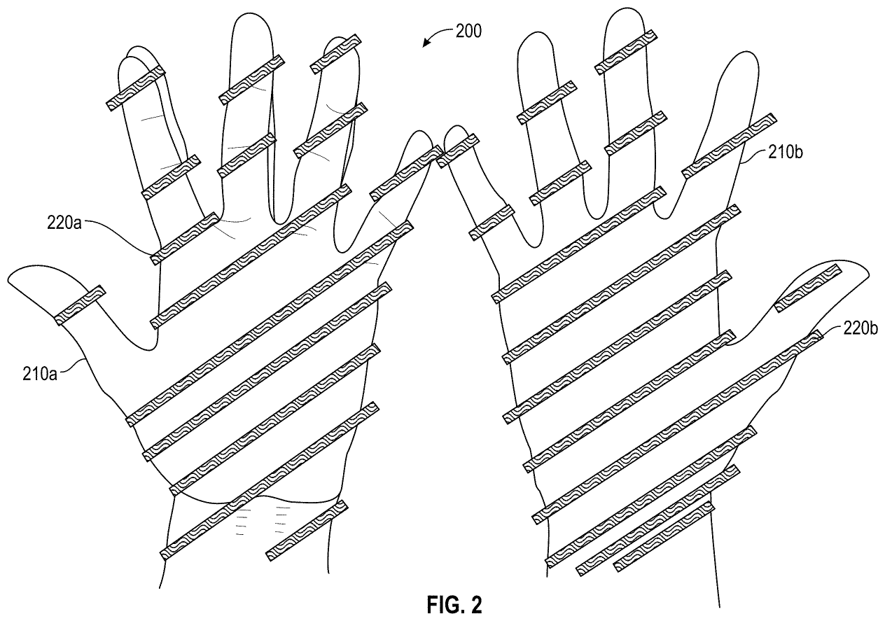

Turning to FIG. 2, shown is a schematic 200 of high-pressure, repeating focal regions that continually drain with an acoustic structure that behaves much like an Archimedes screw. A moving pressure field in the configuration of an Archimedes screw actively pushes water towards the tips of each of the fingers to pool and fall away. The left illustration shows the palm and front of the hand 210a with the lines of heightened pressure 220a, while the right side shows the back of the hand 210b, with the lines of force 220b winding around to move the liquid forward.

As the spiral pattern of high acoustic pressure turns around the wetted area as time moves forward, the “thread” of the Archimedean screw structure contains liquid that is propelled towards the edges. But if the spiral pattern is moved too quickly, the liquid will not react and drying time will increase. If the spiral pattern is moved too slowly, the liquid will move too slowly and drying time will increase.

An optimal speed of the spiral pattern may be calculated. Relative to sound waves in air, capillary waves are characterized by short wavelength and slow speed. For wavelengths short relative to the depth of the fluid, capillary waves can be described by the following dispersion relation:

$${ω}^{2} = \frac{α {k}^{3}}{ρ} \qquad ( 1 )$$

where ω is the angular frequency, k is the wave number, α is the surface tension and ρ is the density of the fluid. At 40 kHz, a typical frequency for airborne ultrasound, the wavelength in air is about 8.5 mm with a propagation speed of 343 m/s under normal conditions. For the same frequency, capillary waves have a wavelength of 0.066 mm with a propagation speed of 2.6 m/s given by equation 1. This illustrates the difficulty in creating efficient coupling between the two systems.

Diffraction limits the ability of any monochromatic system to create features smaller than the wavelength. In fact, any high-pressure finite focal region will contain higher frequency components near its edges due to spatial frequencies and nonlinear effects. If these higher frequency points, lines or regions are translated at the correct speed to match the desired capillary mode speed (such as 2.6 m/s for plane waves given above), this will increase coupling to that mode. In one arrangement, the higher frequency regions may be focus points or lines that move at capillary speeds. Ideally, these regions would spend more time in locations with more water concentration.

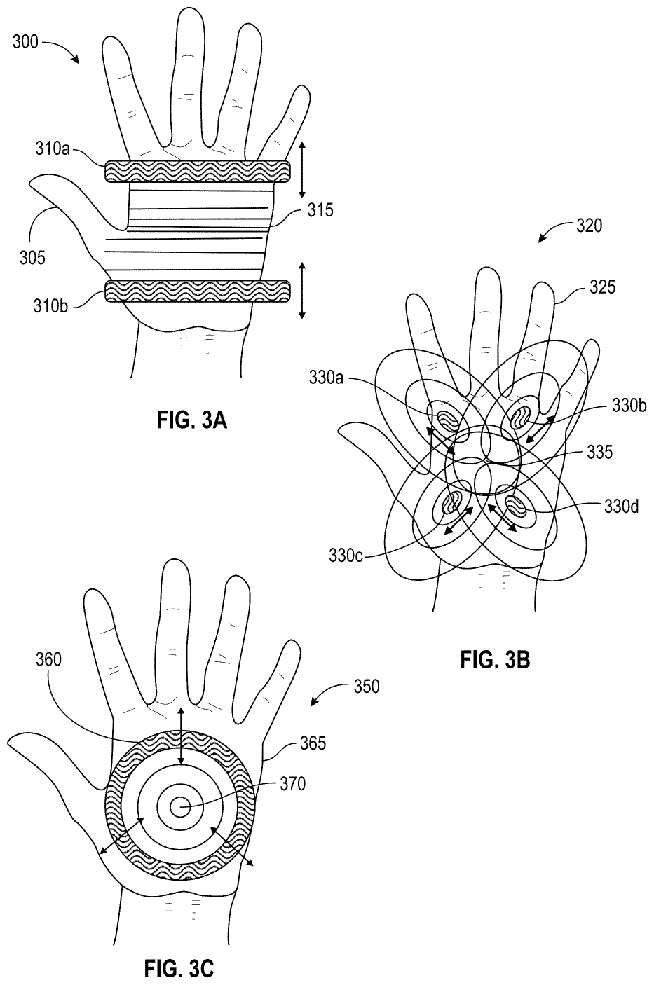

Turning to FIGS. 3A, 3B and 3C, shown are examples of one or more focal regions that may be designed to create converging capillary wave mode to further increase the amplitude of oscillation to a point necessary to create the pinch-off instability. These may take the form of oscillating points/regions that send capillary waves emanating away from them which then can interact and focus.

The figures show oscillating pressure fields that launch capillary waves into a convergence point of highest pressure. FIG. 3A shows a schematic 300 of a hand 305 where the focal regions 310a, 310b are rectangular shaped and operate vertically to converge at a center horizontal line 315 on the hand 305. FIG. 3B shows a schematic 320 of a hand 325 where the focal regions 330a, 330b, 330c, 330d are oval shaped and operate diagonally to converge at a center point 335 on the hand 325. FIG. 3C shows a schematic 350 of a hand 365 where the focal region 360 is circular shaped and operates radially to converge at a center point 370 on the hand 365.

Alternatively, single points or trains of points may propagate to one or more common centers pushing the capillary waves into a focus. Here, translating pressure fields launch capillary waves into a convergence point of highest pressure.

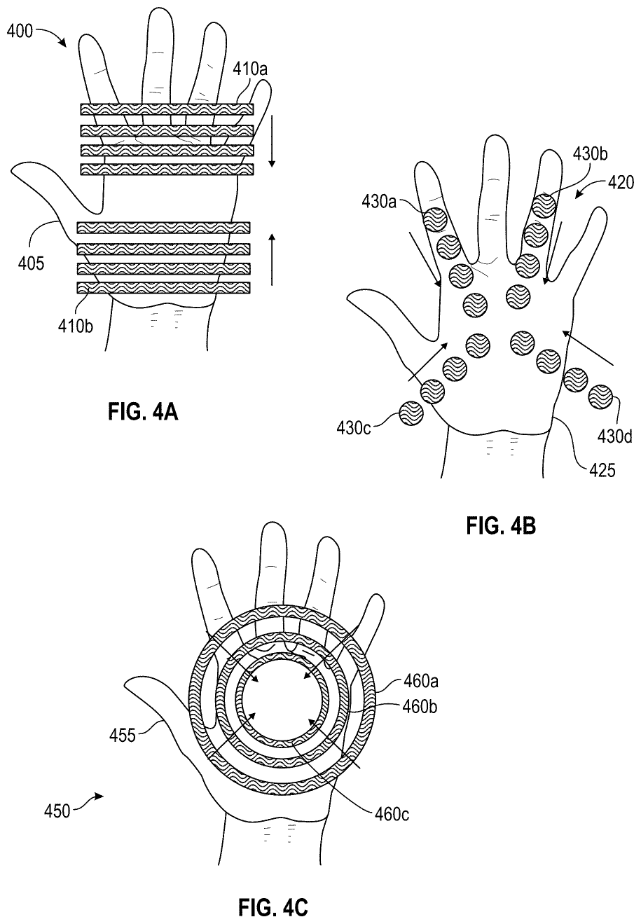

Turning to FIGS. 4A, 4B and 4C, shown are translating pressure fields on a hand that launch capillary waves into a convergence point of highest pressure. FIG. 4A shows a schematic 400 of a hand 405 where the pressure fields 410a, 410b are rectangular shaped and translate in a vertical direction. FIG. 4B shows a schematic 420 of a hand 425 where the focal regions 430a, 430b, 430c, 430d are circular shaped to translate in various diagonal directions. FIG. 4C shows a schematic 450 of a hand 455 where the pressure fields are circular shaped and translate in a radial direction.

In either of these two cases, the convergence point(s) are translated around in order to dry the entire hand.

Nonlinearities may be exploited to create repetitive features and overcome the diffraction limit. At high pressure, sound waves exhibit steepening whereby the high-pressure portion of the pressure wave moves slightly faster than the low-pressure portion. This eventually leads to the formation of shock waves.

This sharp region of pressure may be used (either before or after a true shock forms) to create sharp features by combining multiple wave fronts.

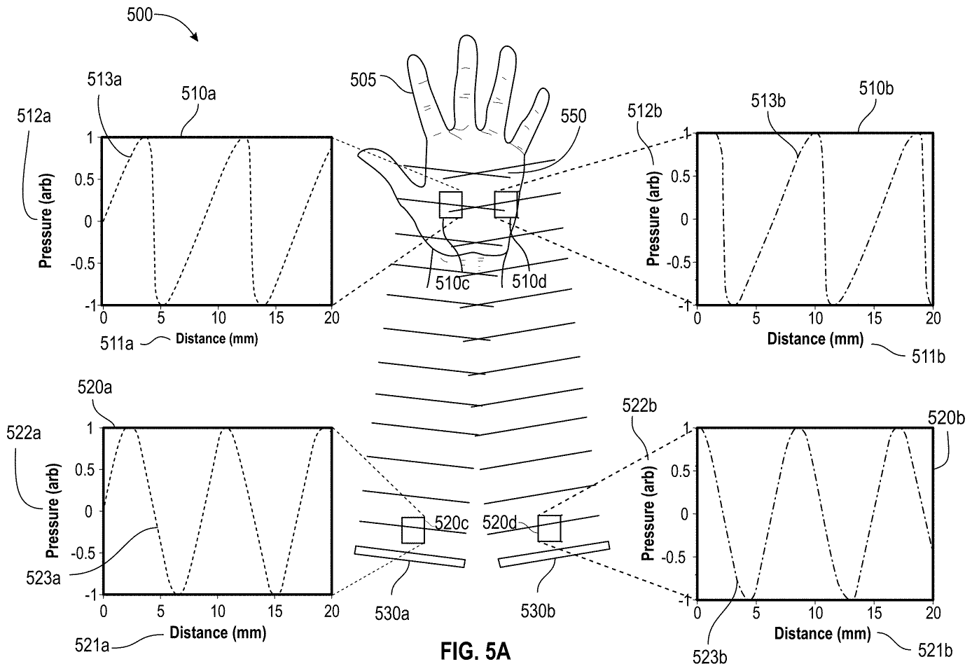

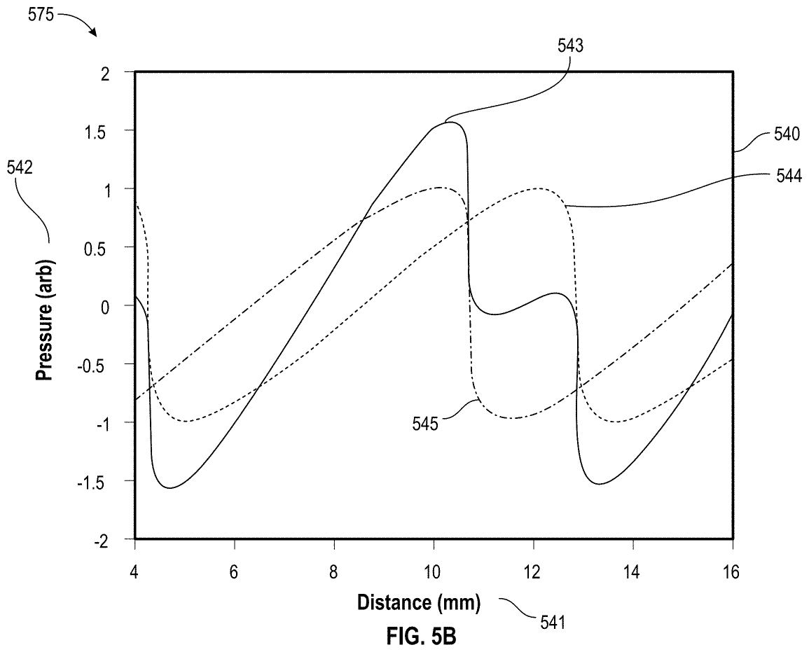

Turning to FIG. 5A, shown is a schematic 500 demonstrating the effect of diagonal converging nonlinear pressure fields that yield sharp features. A left pressure field 530a and a right pressure field 530b converge at a location 550 on a hand 505.

The plots of the bottom left graph 520a and the bottom right graph 520b show clean emitted waves that show no wave “tilting”. The bottom left graph 520a shows a clean emitted wave 523a and is a close-up of waves at a location 520c within the left pressure field 530a relatively distant from the convergence location 550. The x-axis 521a shows distance in millimeters. They-axis 522a shows pressure in arbitrary units. The bottom right graph 520b shows a clean emitted wave 523b and is a close-up of waves at a location 520d within the right pressure field 530b relatively distant from the convergence location 550. The x-axis 521b shows distance in millimeters. The y-axis 522b shows pressure in arbitrary units.

The top left graph 510a and the top right graph 510b show sound waves exhibit steepening whereby the high-pressure portion of the pressure wave moves slightly faster than the low-pressure portion. The plots in these graphs show wave “tilting” that result from the steepening.

Specifically, the top left graph 510a shows a steepened wave 513a (represented by a dashed line) that produces the left pressure field 530a and is a close-up of waves at a location 510c on or near the convergence location 550. The x-axis 511a shows distance in millimeters. The y-axis 512a shows pressure in arbitrary units.

The top right graph 510b shows a steepened wave 513b (represented by a dot-dashed line) that produces the right pressure field 530b and is a close-up of waves at a location 510d on or near the convergence location 550. The x-axis 511b shows distance in millimeters. The y-axis 512b shows pressure in arbitrary units.

Turning to FIG. 5B, shown is a graph 575 that shows diagonal nonlinear pressure fields yield sharp features when they a converge at a location 550 on the hand 505. Like the graphs in FIG. 5A, the x-axis 541 shows distance in millimeters and the y-axis 542 shows pressure in arbitrary units. The plot of the dashed line 544 is equivalent to the left steepened wave shown in the plot of the top left graph 510a in FIG. 5A. The plot of the dot-dashed line 545 is equivalent to the right steepened wave shown in the plot of the top left graph 510b in FIG. 5A. The plot of the solid line 543 represents the cumulative effect of the two steepened waves 544, 545 at their convergence 550 on the hand 505. This solid line plot 543 shows the sharp features that may occur as a result of this convergence. In this example, the sharp features occur approximately between 11 to 13 millimeters of distance.

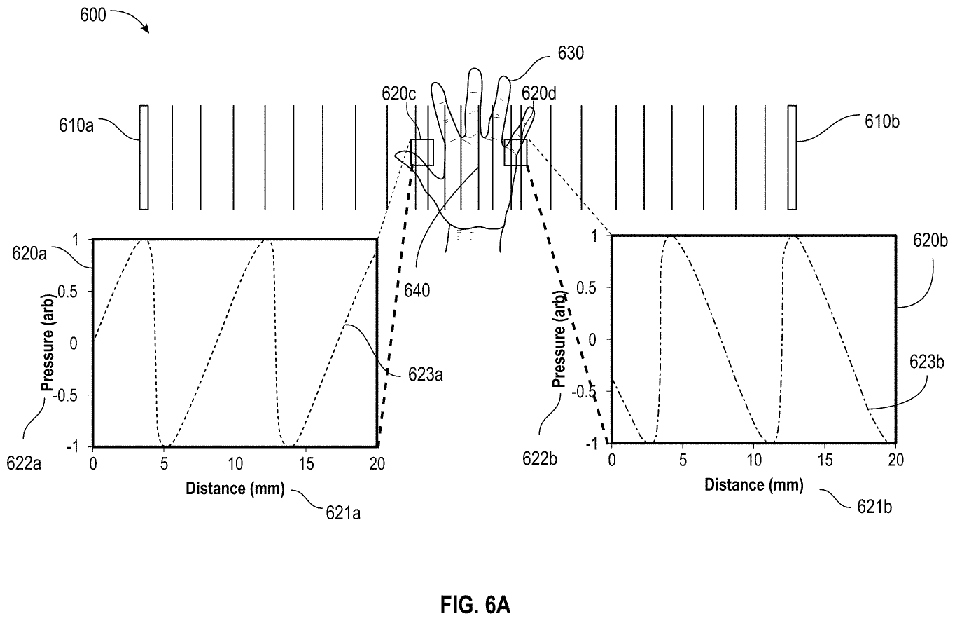

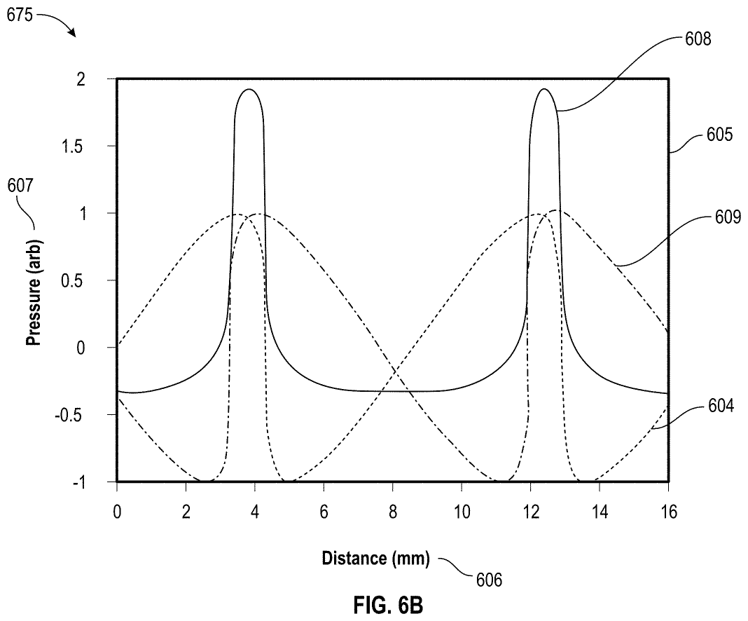

Turning to FIG. 6A, shown is a schematic 600 demonstrating the effect of facing nonlinear pressure fields that yield sharp features. A left pressure field 610a and a right pressure field 610b converge at a location 640 on a hand 630.

The left graph and the right graph show sound waves exhibit steepening whereby the high-pressure portion of the pressure wave moves slightly faster than the low-pressure portion. The plots in these graphs show wave “tilting” that result from the steepening.

Specifically, the left graph 620a shows a steepened wave 623a (represented by a dashed line) that produces the left pressure field 610a and is a close-up of waves at a location 620c on or near the convergence location 640. The x-axis 621a shows distance in millimeters. The y-axis 621a shows pressure in arbitrary units.

The right graph 620b shows a steepened wave 623b (represented by a dot-dashed line) that produces the right pressure field 610b and is a close-up of waves at a location 620d on or near the convergence location 640. The x-axis 621b shows distance in millimeters. They-axis 621b shows pressure in arbitrary units.

Graphs corresponding to the bottom left graph 520a and bottom right graph 520b in FIG. 5A are not shown in FIG. 6A but would reflect similar data.

Turning to FIG. 6B, shown is a graph 675 that shows facing nonlinear pressure fields yield sharp features when they a converge at a location 640 on the hand 630. Like the graphs in FIG. 6A, the x-axis 606 shows distance in millimeters and they-axis 607 shows pressure in arbitrary units. The plot of the dashed line 604 is equivalent to the left steepened wave shown in the plot of the left graph 602a in FIG. 6A. The plot of the dot-dashed line 609 is equivalent to the right steepened wave shown in the plot of the top left graph 602b in FIG. 6A. The plot of the solid line 608 represents the convergence of the steepened waves 604, 609. This solid line plot 608 shows the sharp features that may occur as a result of this convergence. In this example, the sharp features occur approximately between 3 to 5 and between 11.5 and 13.5 millimeters of distance.

FIGS. 5A, 5B and 6A, 6B are examples where at least two transducers create high pressure wave fronts in physically distinct areas that overlap after some distance. The distance before interaction needs to be long enough to cause significant steepening before the waves combine. This distance will depend on the pressure and frequency of the sound waves and can be as short as a few centimeters. If fired near perpendicular to the surface of the fluid and angled so that they are substantially parallel w % ben they combine, it is possible to create a pressure feature traveling across the surface of the fluid at the desired capillary wavelength which will improve coupling.

To further improve this method, many wave fronts may be used to create by separate systems to build a shock wave train with the correct wavelength spacing to maximally couple to capillary waves. In another arrangement, one or more phased arrays could be used. In this arrangement, half of the array could function as one transducer and the other half could be the other. If using one or more phased arrays it is possible to further shape the acoustic field in order to make higher-pressure regions and translate those regions to desired locations.

Differences in speed of sound may be overcome by setting up a standing wave condition. In this arrangement, a series of shock fronts are created propagating one direction (say positive x-direction) and another wave-train is fired from another set of arrays in the opposite direction (−x in this example). As they pass through each other, the resulting pressure field will have features which can be the correct length-scale. This will increase coupling to the desired capillary wave mode. The “standing wave” is not a true repeating sine wave in the traditional sense but merely a pressure profile that repeats itself at the frequency of the ultrasound.

The high-pressure and/or sharp features may be moved around by changing the phasing between the ultrasonic transducers. Sound waves transmitted from one transducer will reach the opposing transducer and reflect back into the drying environment. In one arrangement, this may be used to add to the transmitted ultrasound from that transducer. If the sharp sound features are to be translated in this arrangement, the transducers will need to translate in space slightly as well as in phase. In another arrangement the transducers may be angled (or phased) slightly so that their beams do not intersect with the opposite transducer.

In another arrangement each transducer may a phased array. The phased arrays allow arbitrary fields to be created and, in this case, may create intersecting focus spots. Just like the parallel transducers, the interacting focus spots will contain sharp features due to wave steepening. The phased arrays may translate this focus point as well as manipulate the phase of each array allowing for arbitrary sharp feature translation to dry the entire hand efficiently. In this arrangement, reflected fields will be unimportant since they will scatter instead of focusing. Monochromatic sound, while typically the easiest to create, is not a requirement.

In another arrangement, broadband acoustic fields may be used. With sufficient bandwidth, arbitrarily-shaped acoustic pressure fields may be created at sharp moments in time. To optimally couple to capillary waves, a repetitive acoustic pattern may be projected onto the hand with the correct wavelength/shape for the desired capillary mode. After the first pulse hits, the pressure field would disperse so as to drive the capillary mode and a repetitive series of pulses at the desired frequency would need to be made. These may be identically shaped or evolve in time with the desired capillary mode.

As the water from the hand is removed, the wetted film becomes thinner and equation 1 no longer applies. The propagation speed begins to change as hand the above methods will need to compensate. Thickness change from evaporation may be modeled, and in one arrangement the system may start with a maximum possible assumed thickness and then progress towards thinner films. Given it started at a maximum, at some point the system will encounter the actual film thickness and then enhancement will take place and it will progress towards the (dry) endpoint. Alternatively, the system may measure the average wetting thickness as the user starts the dryer (such as a laser interference method) and the system will start at that value.

In another arrangement, since thickness will influence optimal coupling, monitoring the thickness may be done by looking at the return acoustic power. As the film drifts out of optimal coupling, more sound will be reflected and the system may adjust to compensate until a chosen end-point is reached. In yet another arrangement, the film thickness may be continually monitored using a light-based technique and this information is passed to the ultrasonic system. This may be used as feedback to hold the system in optimal coupling.

Liquid manipulation needs focused fields but not necessarily a phased array (although that makes it much easier). The non-phased-array version would need the entire transducer network to translate the liquid where its field is being projected.

### II. ADDITIONAL DISCLOSURE

The following numbered clauses show further illustrative examples only:

1. A method of liquid manipulation comprising the steps of

Providing a plurality of ultrasonic transducers having known relative positions and orientations;
Defining a plurality of control fields wherein each of the plurality of control fields have a known spatial relationship relative to the transducer array;
Defining a control surface onto which the control fields will be projected; and Orienting the control fields onto the surface so that liquid on that surface is adjusted.

2. A method as in claim 1 where the adjustment is position.

3. A method as in claim 1 where the adjustment is thickness.

4. A method as in claim 1 where the adjustment is flow/particle velocity.

5. A method as in claim 1 where the control fields are dynamically updated as the liquid is adjusted.

6. A method as in claim 1 where the field induces cavitation in the liquid.

7. A method as in claim 1 where the transducer's positions are adjusted to adjust the liquid.

8. A method of de-wetting of an object/person comprising the steps of:

Producing an acoustic field directed at a wetted object/person;
Setting the amplitude or phasing or shape of the acoustic field to de-wet the object/person.

9. A method as in claim 8 where the acoustic field is within a resonant chamber.

10. A method as in claim 8 where the object/person is also subjected to forced air.

11. A method as in claim 8 where the liquid on the wetted object/person experiences improved mass-transfer.

12. A method as in claim 8 where the liquid experiences drop pinch-off from capillary waves.

13. A method as in claim 8 where the acoustic field takes the form of a rotating spiral.

14. A method as in claim 8 where the acoustic field can be adjusted by adjusting the position or phase of one or more transducers.

15. A method as in claim 14 where the transducer(s) create focus regions.

16. A method as in claim 15 where those focus regions are translated across the object/person.

17. A method as in claim 16 where the focus regions push water off the object/person.

18. A method as in claim 16 where the focus regions push water off hands or fingers.

19. A method as in claim 15 where the focus regions move at a speed which improves coupling to capillary waves.

20. A method as in claim 15 where the focus regions occur at a spacing which improves coupling to capillary waves.

21. A method as in claim 15 where translating focus fields are arranged in such a way that converging capillary waves are created.

22. A method as in claim 8 where acoustic fields are arranged so that nonlinear wave steepening creates sharp features.

23. A method as in claim 22 where 2 sources are close to parallel whose sharp features combine after some distance.

24. A method as in claim 22 where 2 sources are close to parallel facing each other whose sharp features combine after some distance.

25. A method as in claim 8 which uses a broadband system to create an acoustic field which has high-pressure features which couples to capillary waves.

26. A method as in claim 8 where the amplitude or phasing changes as wetting thickness changes.

27. A method as in claim 26 which includes a sensor to detect wetting thickness.

28. A method as in claim 26 which includes a sensor to measure reflected ultrasound.

### III. CONCLUSION

While the foregoing descriptions disclose specific values, any other specific values may be used to achieve similar results. Further, the various features of the foregoing embodiments may be selected and combined to produce numerous variations of improved haptic systems.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”. “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method of liquid manipulation comprising the steps of:
establishing a transducer array having a plurality of ultrasonic transducers having known relative positions and orientations;
defining a plurality of control fields wherein each of the plurality of control fields has a known spatial relationship relative to the transducer array;
defining a control surface onto which the plurality of the control fields will be projected;
orienting the control fields onto the control surface so that liquid on the control surface is adjusted.

2. A method as in claim 1, wherein the plurality of control fields are dynamically updated as the liquid is adjusted.

3. A method as in claim 1, wherein the plurality of control fields induce cavitation in the liquid.

4. A method as in claim 1, wherein positions of the transducer array are altered to adjust the liquid.

5. A method of de-wetting a human body part comprising the steps of:
establishing a transducer array having a plurality of ultrasonic transducers having known relative positions and orientations;
using the transducer array to produce an acoustic field directed at a wetted human body part; and
setting an acoustic field parameter selected from the group consisting of frequencies, amplitudes, phasings, and shapes to de-wet the wetted human body part.

6. A method as in claim 5, wherein the acoustic field is within a resonant chamber.

7. A method as in claim 5, wherein the human body part is also subjected to forced air.

8. A method as in claim 5, wherein liquid on the human body part experiences improved mass-transfer.

9. A method as in claim 5, wherein liquid on the human body part experiences drop pinch-off from capillary waves.

10. A method as in claim 5, wherein the acoustic field is adjusted by adjusting a position or phase of at least one of the plurality of ultrasonic transducers.

11. A method as in claim 10, wherein at least one of the plurality of ultrasonic transducers create focus regions.

12. A method as in claim 11, wherein the focus regions are translated across the human body part.

13. A method as in claim 12, wherein the focus regions push water off the human body part.

14. A method as in claim 13, wherein the human body part comprises a hand.

15. A method as in claim 11, wherein the focus regions move at a speed that improves coupling to capillary waves.

16. A method as in claim 11, wherein the focus regions occur at a spacing that improves coupling to capillary waves.

17. A method as in claim 11, further comprising:
translating focus fields that create converging capillary waves.

18. A method as in claim 5, wherein the acoustic fields are arranged so that nonlinear wave steepening creates sharp features.

19. A method as in claim 5, wherein a broadband system that creates the acoustic field has high-pressure features coupled to capillary waves.

20. A method as in claim 5, wherein the acoustic field parameter changes as wetting thickness changes.
